(19) United States
(12) Patent Application Publication
(10) Pub. No.: US 2018/0336446 A1
(43) Pub. Date: Nov. 22, 2018

(54) LOST AND FOUND SYSTEMS, METHODS, AND DEVICES

(71) Applicant: Marc Elkowitz, Old Westbury, NY (US)

(72) Inventor: Marc Elkowitz, Old Westbury, NY (US)

(21) Appl. No.: 15/977,515

(22) Filed: May 11, 2018

Related U.S. Application Data
(60) Provisional application No. 62/505,616, filed on May 12, 2017.
(60) Provisional application No. 62/571,062, filed on Oct. 11, 2017.

(51) Int. Cl. G06K 19/06; G06K 7/14; H04L 12/58

(52) U.S. Cl. CPC G06K 19/06037; H04L 51/046; G06K 7/1417

(57) ABSTRACT

A lost-and-found label for a lost and found system can include an adherent surface for attaching the label to an item, a viewing surface on an opposite side of the label from the adherent surface, a bar code registerable with the lost and found system printed on the viewing surface of the label, and a text message number printed adjacent the bar code on the viewing surface of the label. The text message number can be linked to a server configured to receive and interpret an image of the bar code to determine if the bar code is registered to an item registered within the lost and found system such that the bar code and the text message number combination allow a finder to send an image of the bar code to the server via text message to report a found item and to receive a response from the lost and found system.

### CROSS-REFERENCE TO RELATED APPLICATIONS

This application claims priority to and the benefit of U.S. Provisional Application No. 62/505,616, filed May 12, 2017, and U.S. Provisional Application No. 62/571,062, filed Oct. 11, 2017, the entire content of each being herein incorporated by reference in their entirety.

### BACKGROUND

### 1. Field

The present disclosure relates to lost and found systems and methods.

### 2. Description of Related Art

Certain systems exist for returning lost items to the original owners thereof. Existing systems have not been sufficient to enable and/or to cause people to utilize them, thereby causing lost items to remain lost.

Such conventional methods and systems have generally been considered satisfactory for their intended purpose. However, there is still a need in the art for improved lost and found systems and methods. The present disclosure provides a solution for this need.

### SUMMARY OF THE DISCLOSURE

A lost-and-found label for a lost and found system can include an adherent surface for attaching the label to an item, a viewing surface on an opposite side of the label from the adherent surface, a bar code registerable with the lost and found system printed on the viewing surface of the label, and a text message number (e.g., an SMS number) printed adjacent the bar code on the viewing surface of the label. The text message number can be linked to a server configured to receive and interpret an image of the bar code to determine if the bar code is registered to an item registered within the lost and found system such that the bar code and the text message number combination allow a finder to send an image of the bar code to the server via text message to report a found item and to receive a response from the lost and found system.

The bar code can be a QR code (i.e., a 2D bar code), for example, or any other suitable single dimension or multi-dimensional bar code. The text message number can be a phone number (or any other suitable SMS address, e.g., a 5 digit SMS number). The label can include a use indicator (e.g., instructions that indicate how to use the label printed on the viewing surface). For example, the label can include the term “TEXT A PHOTO OF THIS LABEL TO” or similar term adjacent the text message number.

In certain embodiments, the label can include a reward indicator on the viewing surface (e.g., print that indicates a reward will be given for return of the lost item, the print being printed on the viewing surface). For example, the print can include the term “REWARD.”

In accordance with at least one aspect of this disclosure, a computer-implemented method can include receiving a text message from a mobile device of a finder comprising an image of a lost-and-found label, reading a bar code in the image of the label, comparing the bar code to a database of registered items to determine if the bar code is registered to an item, if the bar code is registered to an item, determining the item to be a found item, and sending one or more response text messages to the mobile device that sent the image to execute a return and reward procedure.

In certain embodiments, the one or more response text messages can include an image of a return shipping label. The one or more response text messages can include a link to an app or website associated with the lost and found system for additional information to be input. In certain embodiments, the method can include receiving a finder's shipping address from the finder and causing shipment of a return box of a predetermined size configured to fit the found item therein and a shipping label to the finder's shipping address.

A server can include a memory, a processor disposed in communication with said memory, and configured to issue a plurality of instructions stored in the memory, wherein the instructions cause the processor to perform a method as disclosed herein. The server can be any number and/or combination of computerized devices connected together in any suitable manner to perform any suitable portion(s) of the method as disclosed herein. For example, in certain embodiments, a non-transitory computer readable medium can include computer executable instructions to perform any suitable method and/or any suitable portion(s) thereof as disclosed herein.

### BRIEF DESCRIPTION OF THE DRAWINGS

The accompanying appendices and/or drawings illustrate various non-limiting, example, aspects in accordance with the present disclosure:

FIG. 1 illustrates an example communication network in accordance with this disclosure;

FIG. 2 illustrates an example network device/node in accordance with this disclosure;

FIG. 3 illustrates a flow chart of an embodiment of a method and/or system in accordance with this disclosure; and

FIG. 4 illustrates an embodiment of a method in accordance with this disclosure;

FIG. 5 illustrates an embodiment of an enrollment method in accordance with this disclosure;

FIG. 6 illustrates an embodiment of a login method in accordance with this disclosure;

FIG. 7 illustrates an embodiment of a method in accordance with this disclosure;

FIG. 8 illustrates an embodiment of a method in accordance with this disclosure;

FIG. 9 illustrates an embodiment of data architecture in accordance with this disclosure;

FIG. 10 illustrates an embodiment of a method in accordance with this disclosure;

FIG. 11A and 11B illustrate an embodiment of a method in accordance with this disclosure;

FIG. 12 illustrates an embodiment of a method in accordance with this disclosure;

FIG. 13A illustrates a plan view of an embodiment of a label in accordance with this disclosure; and

FIG. 13B illustrates a side elevation view of the label of FIG. 13A.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below can be a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

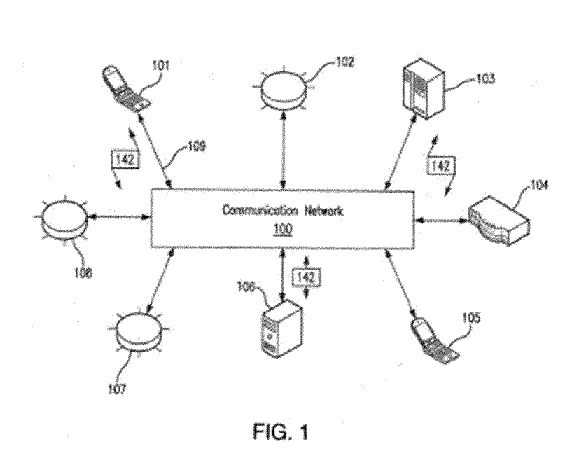

Turning now descriptively to the drawings, in which similar reference characters denote similar elements throughout the several views, FIG. 1 depicts an exemplary communications network 100 in which below illustrated embodiments may be implemented.

It is to be understood a communication network 100 can be a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of this disclosure may be embodied as a system, method or computer program product. Accordingly, aspects of this disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure are described below with reference to flowchart illustrations and/or block diagrams of methods, apparatus (systems) and computer program products according to embodiments of disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

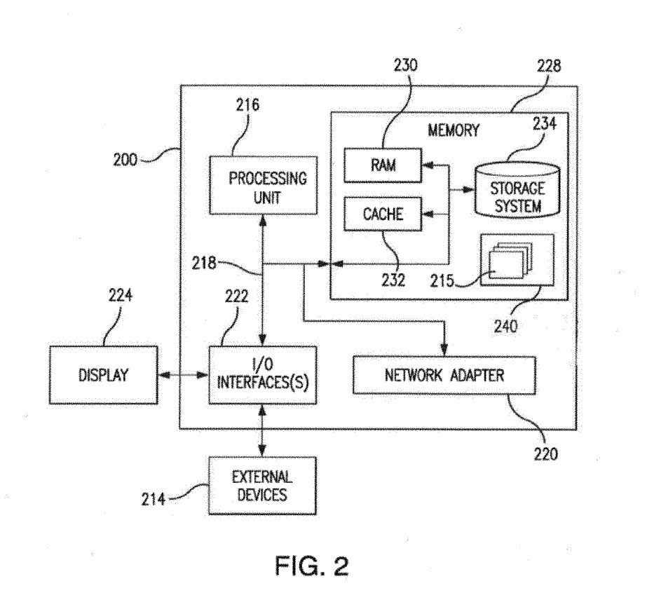

FIG. 2 is a schematic block diagram of an example network computing device 200 (e.g., client computing device 103, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various embodiments of this disclosure. Device 200 is only one example of a suitable system and is not intended to suggest any limitation as to the scope of use or functionality of embodiments of disclosure described herein. Regardless, computing device 200 is capable of being implemented and/or performing any of the functionality set forth herein.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

Device 200 is shown in FIG. 2 in the form of a general-purpose computing device. The components of device 200 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of disclosure.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of disclosure as described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which embodiments of this disclosure may be implemented. FIGS. 1 and 2 are exemplary of a suitable environment and are not intended to suggest any limitation as to the structure, scope of use, or functionality of an embodiment of this disclosure. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

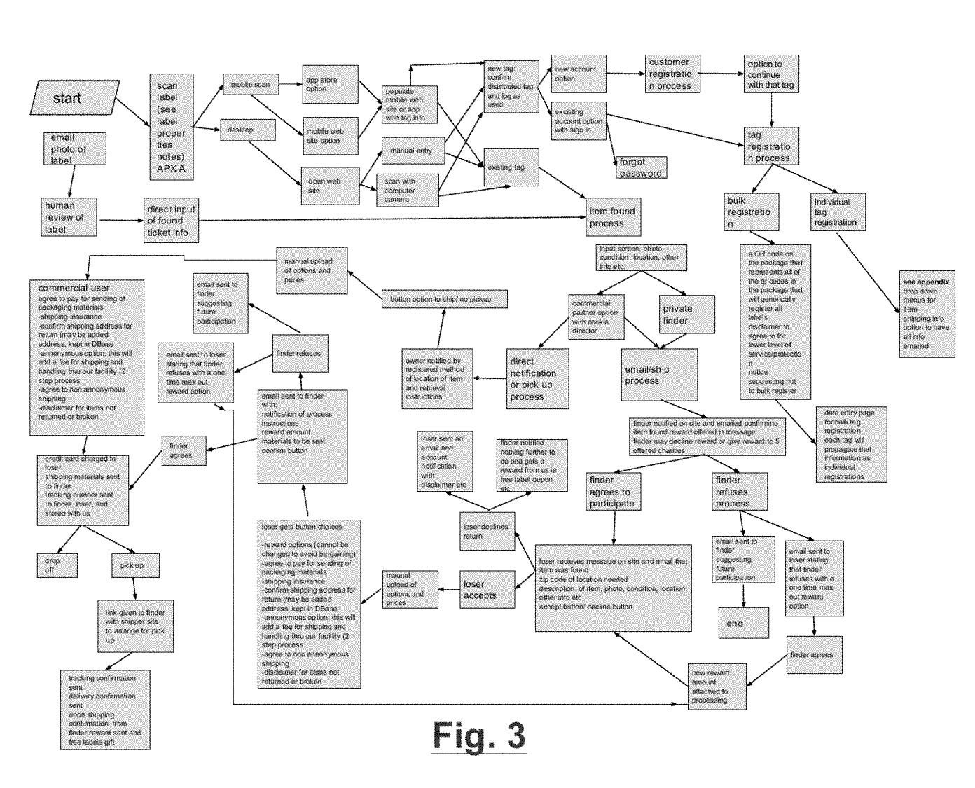

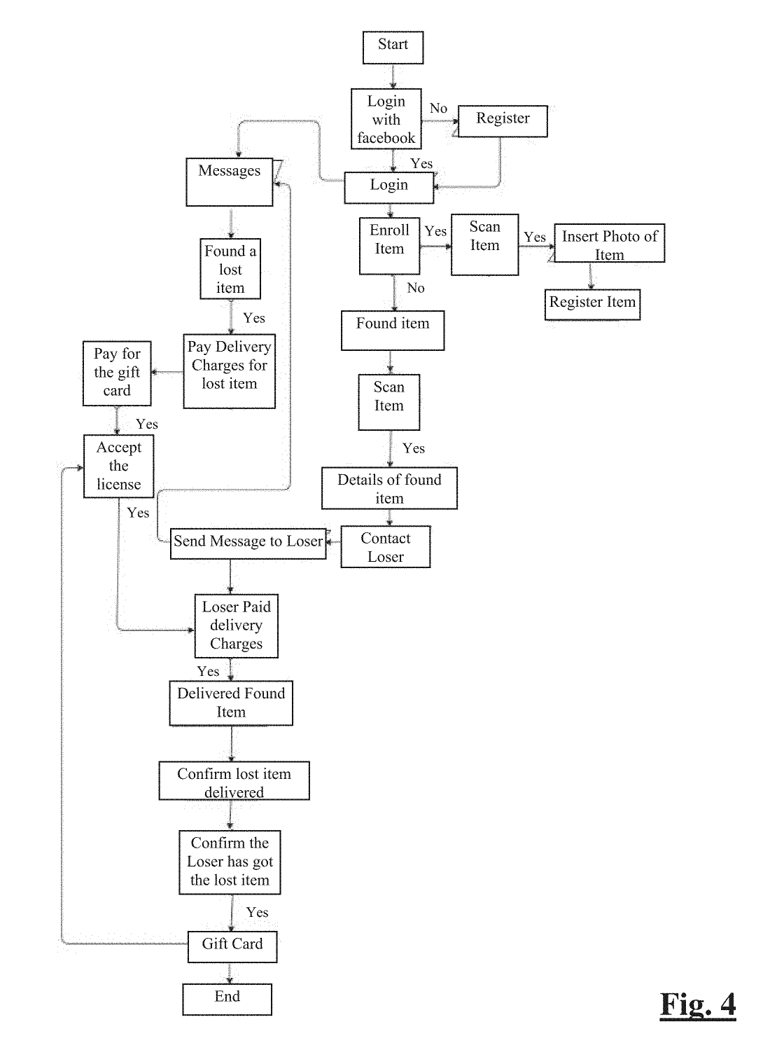

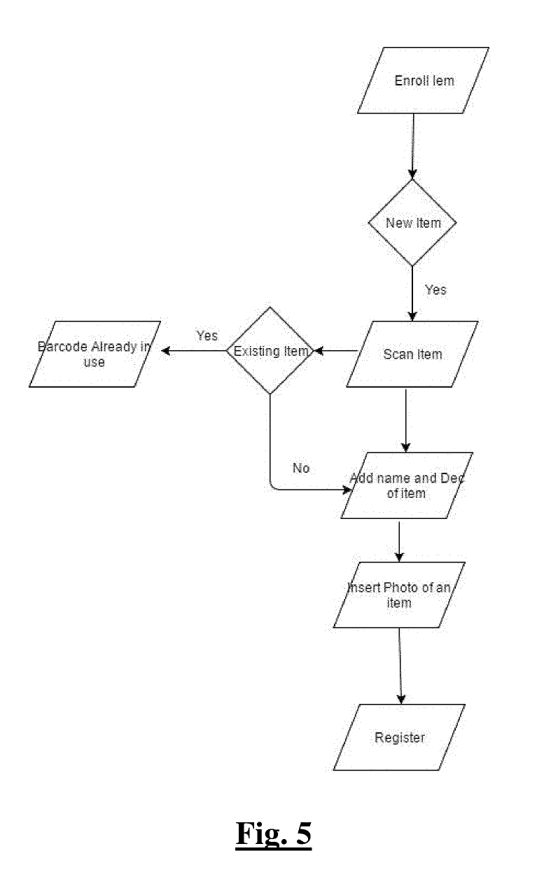

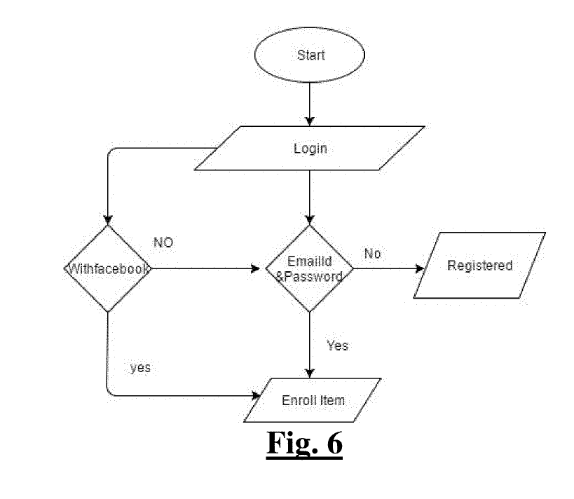

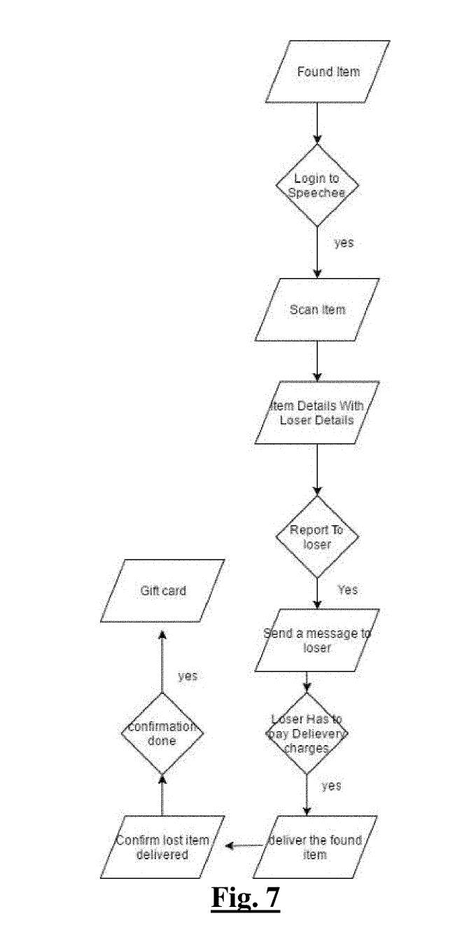

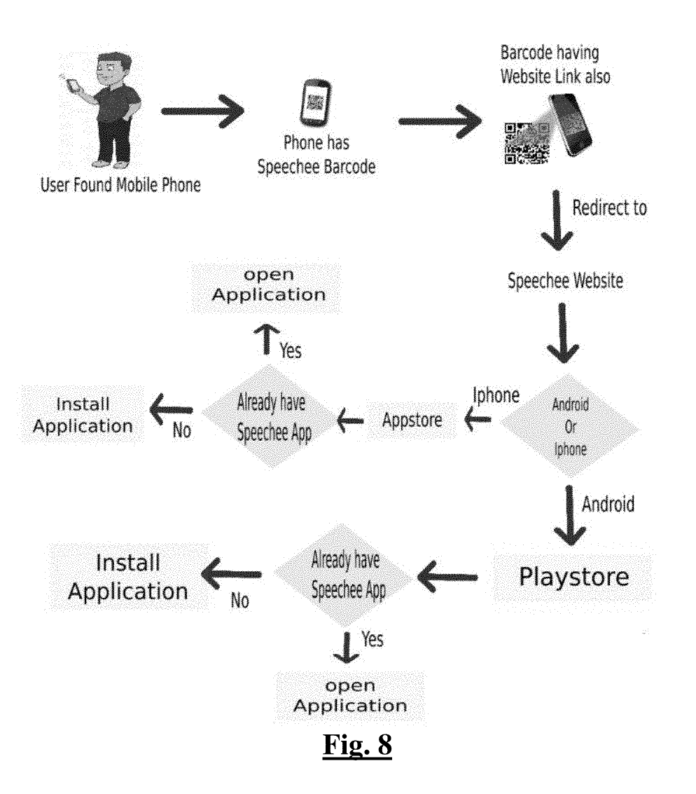

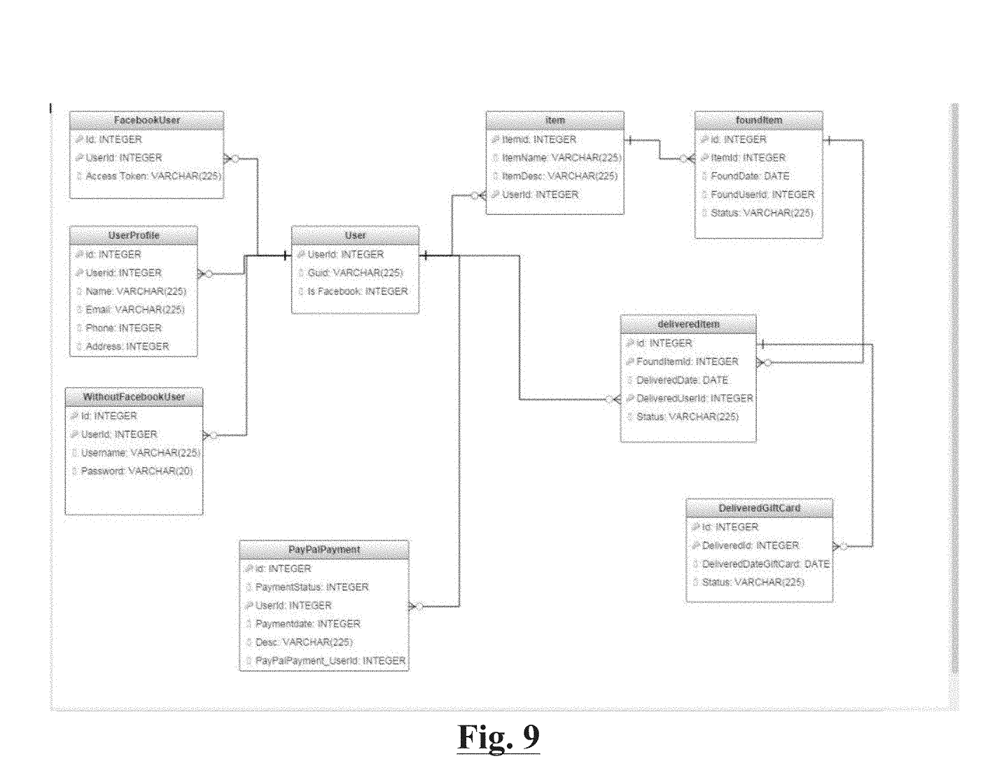

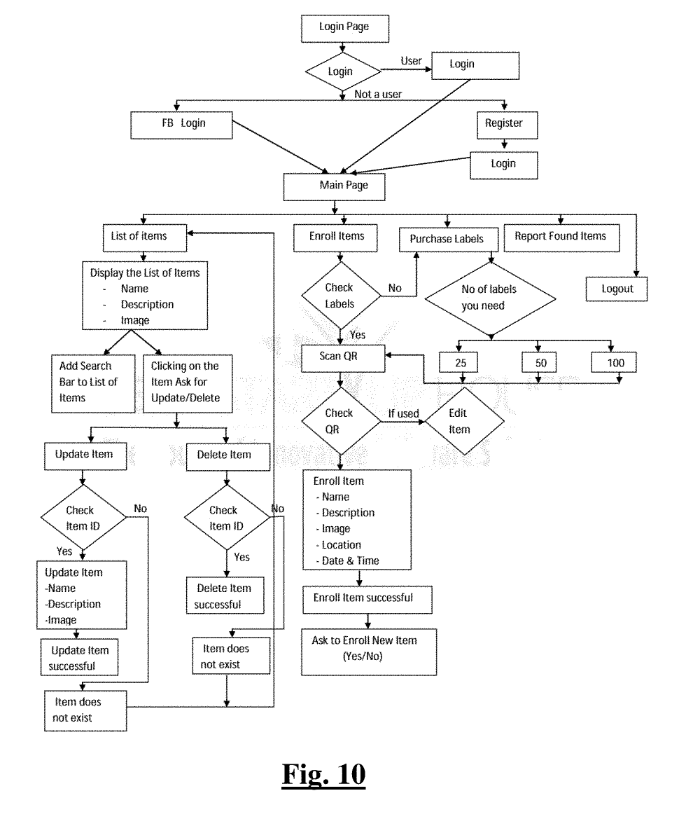

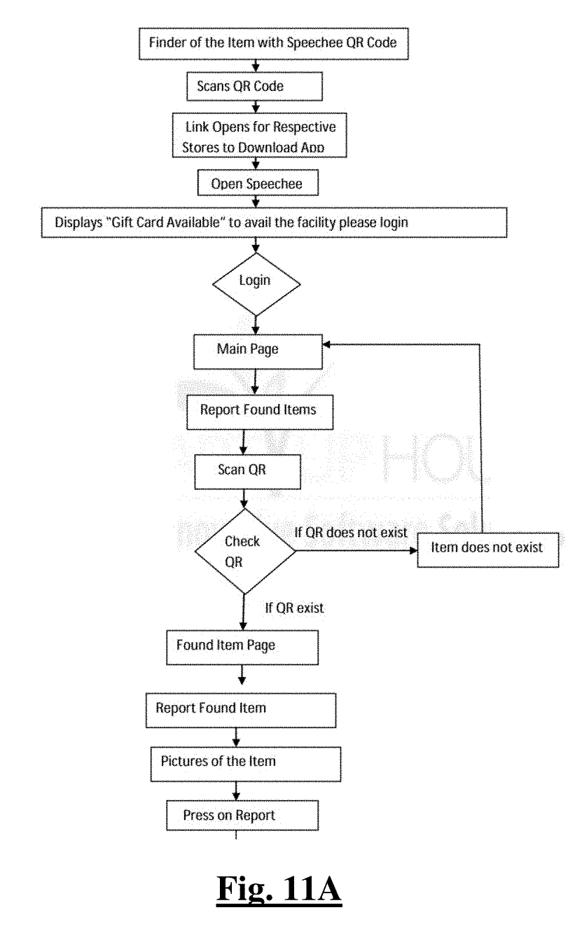

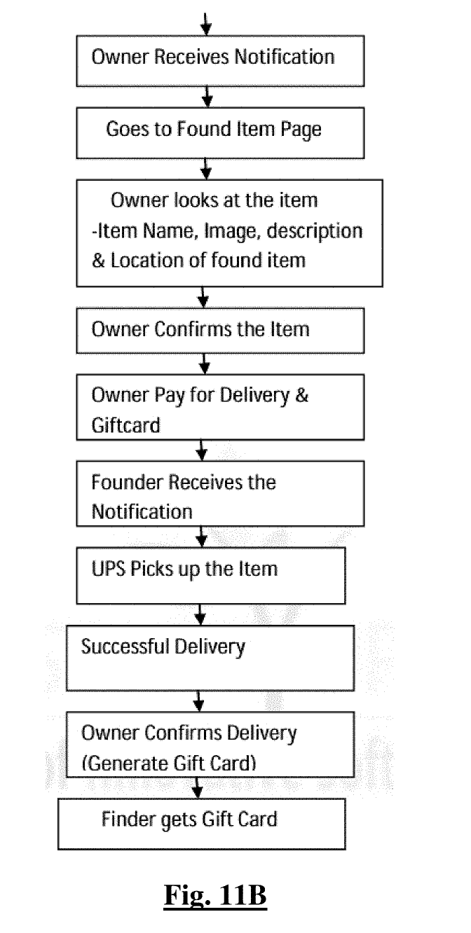

With the exemplary communication network 100 (FIG. 1) and computing device 200 (FIG. 2) being generally shown and discussed above, description of certain illustrated embodiments of this disclosure will now be provided. With reference now to FIGS. 3-12, shown are flow charts demonstrating implementation of various embodiments. It is noted that the order of steps shown in FIGS. 3-12 is not required, so in principle, the various steps may be performed out of the illustrated order. Also certain steps may be skipped, different steps may be added or substituted, or selected steps or groups of steps may be performed in a separate application following the embodiments described herein. Accordingly, FIGS. 3-12 show flow charts of various embodiments of methods, and/or systems, and/or portions thereof in accordance with this disclosure.

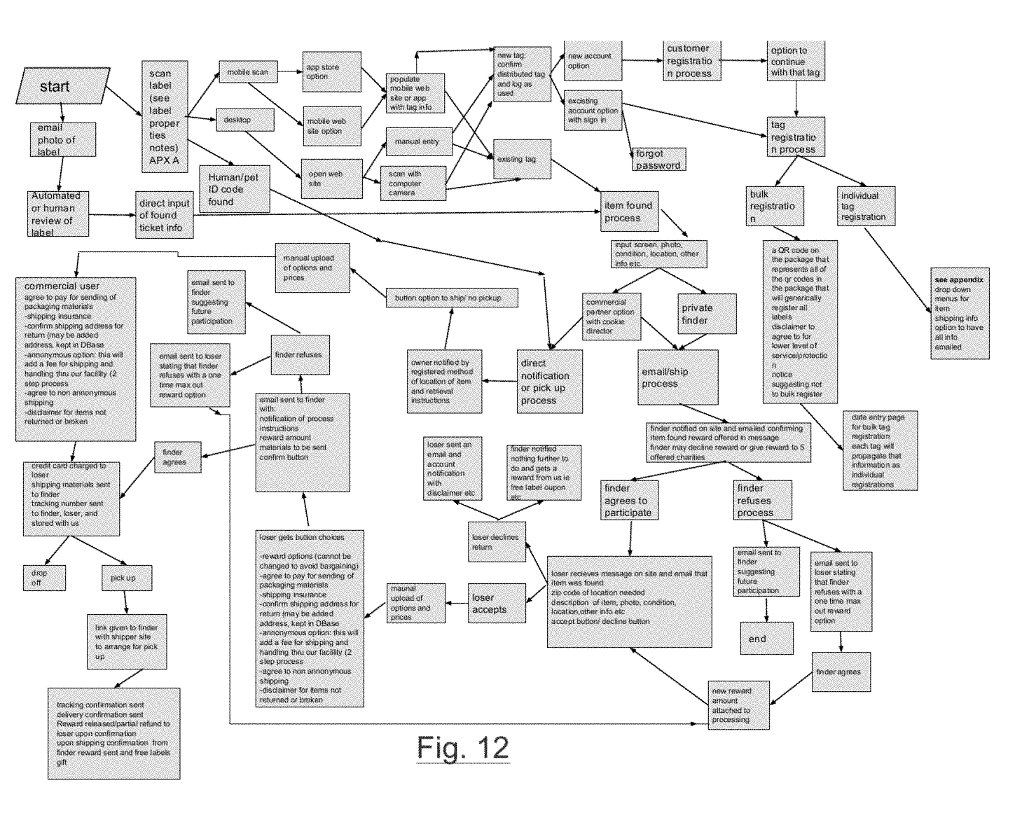

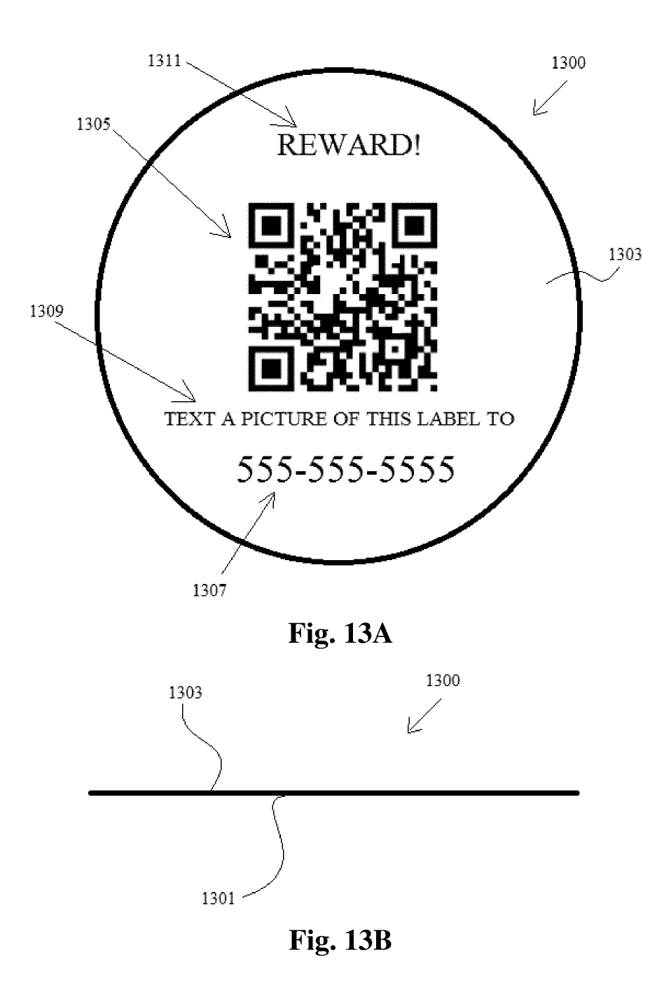

Referring to FIGS. 13A and 13B, a lost-and-found label 1300 (e.g., made of a sheet of paper, plastic, metal foil, etc) for a lost and found system can include an adherent surface 1301 (e.g., as shown in FIG. 13B) for attaching the label 1300 to an item. The adherent surface 1301 can include any suitable adhesive or adherent material to allow the label 1300 to be temporarily or permanently attached to an item. In certain embodiments, the label 1300 can include a removable wax paper covering over the adherent surface 1301 for removal by a user who desires to stick the label 1300 on an item.

The label 1300 includes a viewing surface 1303 on an opposite side of the label 1300 from the adherent surface 1301. The label includes a bar code 1305 registerable with the lost and found system printed on the viewing surface 1303 of the label 1300. The bar code can be a QR code (i.e., a 2D bar code), for example, or any other suitable single dimension or multi-dimensional bar code. As used herein, the term “bar code” can include any suitable machine readable code, not just traditional bar codes (of one or more dimensions).

The label 1300 also includes a text message number 1307 (e.g., which can be an SMS number) printed adjacent the bar code 1305 on the viewing surface of the label 1303. The text message number 1307 can be linked to a server configured to receive and interpret an image of the bar code 1305 to determine if the bar code 1305 is registered to an item registered within the lost and found system such that the bar code 1305 and the text message number 1307 combination allow a finder to send an image of the bar code 1305 to the server via text message to report a found item and to receive a response from the lost and found system. The text message number 1307 can be a phone number or any other suitable SMS number for example.

In certain embodiments, the label 1300 can include a use indicator 1309 (e.g., instructions that indicate how to use the label 1300 printed on the viewing surface 1303). For example, the label 1300 can include the term “TEXT A PHOTO OF THIS LABEL TO” or similar term adjacent the text message number 1307.

In certain embodiments, the label 1300 can include a reward indicator 1311 on the viewing surface 1303. For example, the label 1300 can include print that indicates a reward will be given for return of the lost item, the print being printed on the viewing surface 1303. For example, the reward indicator 1311 can include the term “REWARD.”

As appreciated by those having ordinary skill in the art in view of this disclosure, having a combination of a bar code 1305 and a text message number 1307 linked to a lost-and-found system server provides a label 1300 with functionality not previously available. Any user with a common mobile device capable of text messaging pictures can engage the lost-and-found system without having to download an app, or figure out how to utilize the lost-and-found label. To return the found item to the owner. Such labels can be considered self-contained tracking and communication devices.

In accordance with at least one aspect of this disclosure, a computer-implemented method (e.g., performed by a server) can include receiving a text message from a mobile device of a finder comprising an image of a lost-and-found label and reading a bar code in the image of the label. The method can include comparing the bar code to a database of registered items to determine if the bar code is registered to an item. If the bar code is registered to an item, the method includes determining the item to be a found item and sending one or more response text messages to the mobile device that sent the image to execute a return and reward procedure.

In certain embodiments, there is an encrypted string in the barcode. The encrypted string can be decrypted with one or more encryption keys, e.g., that can be varied for different applications and/or licensed to users for example.

In certain embodiments, the one or more response text messages can include an image of a return shipping label. The one or more response text messages can include a link to an app or website associated with the lost and found system for additional information to be input by the finder (e.g., an address of the finder).

In certain embodiments, the method can include receiving a finder's shipping address from the finder (e.g., via a text message and/or via a website/downloadable app) and causing shipment of a return box of a predetermined size configured to fit the found item therein and a shipping label to the finder's shipping address. This automates the process to provide a properly sized shipping box with paid for shipping to the finder. Also, the provided shipping label can be anonymous, allowing the owner of the item to remain anonymous. Any and/or all other aspects of the method can allow the owner to retain anonymity.

A server can include a memory, a processor disposed in communication with said memory, and configured to issue a plurality of instructions stored in the memory, wherein the instructions cause the processor to perform a method as disclosed herein. For example, the server can include a text message module for receiving one or more text messages (having one or more images) from a linked phone number (i.e., the text message number as described above), and/or sending one or more text message to a mobile device. The server can also include an image decoding module configured to receive the image (e.g., of a label 1300 as described above) and find and/or read a bar code contained within the image. The server can include a database comparison module to compare the bar code to a database of registered items and to determine if the bar code is registered to an item of a user of the lost and found system. The server can also include a shipping module configured to supply the finder with a shipping box and/or a shipping label for returning the found item to the owner. The server can also include a reward module configured to provide a reward to the finder upon indication (e.g., in the lost and found app) by the owner that the found item has been received.

The server can be any number and/or combination of computerized devices connected together in any suitable manner (e.g., locally or on the cloud) to perform any suitable portion(s) of the method as disclosed herein. In certain embodiments, a non-transitory computer readable medium can include computer executable instructions to perform any suitable method and/or any suitable portion(s) thereof as disclosed herein. A system in accordance with this disclosure can include a server as described herein, and one or more of the labels 1300 as described herein.

Embodiments of lost-and-found systems and methods are described that are configured to be implemented via one or more suitable computerized devices (e.g., a mobile device or any other suitable device). Embodiments of devices, e.g., barcodes for use with such systems are disclosed herein as well. The term “SPEECHEE” as used herein is not descriptive of any portion of this disclosure and is a trademark of the applicant. All rights are reserved with respect to this mark.

In accordance with aspects of this disclosure, embodiments can allow bi-directional texting from a person who finds an item to communicate with a server without an application. For example, when a person finds a lost item, they can take a photograph of a lost and found label as described herein and text that photograph to an SMS phone number. The SMS text essage number can be linked to a server such that the server receives the to messages (e.g., which can include image data such as one or more photos or videos of one or more labels) sent to the SMS number. The server can then interpret the image data and identify the label (e.g., the QR code) within that image data. The server can than process the label as a found item automatically.

The information can then be communicated to the owner of the item through any suitable means e.g., as described above such as through messaging and/or through an app). In certain embodiments, the owner of the item and/or the server (e.g., via reply text message) can then communicate with the person who found the item. Personal information, shipping information, and/or receipt of a gift voucher, and/or any other suitable communication can be communicated in any suitable manner (e.g., from the server to the finder) as appreciated by those having ordinary skill in the art.

In certain embodiments, the server can send a link (e.g., HTML) for the finder to click on their smart device which can bring the finder to a data entry platform for the finder to enter data and/or other suitable information. However, it is contemplated that any necessary information gathering can be done by the server requesting suitable information in one or more text messages and receiving a response from the finder in one or more text messages.

Using such embodiments, the finder has the option of doing all communication as a cross-platform process via bi-directional texting with the server instead of the app which removes a step requiring the user to download an app in order to facilitate return of a lost item.

It is contemplated that at least some portions of the methods described herein can be implemented on a remote server (or any other suitable computerized device as described above) that includes a memory, a processor disposed in communication with said memory, and configured to issue a plurality of instructions stored in the memory. The remote server can be accessible to the first user and the other users (e.g., via a suitable network such as the interact). The server can relay/send user lists to users to be displayed on the user's device. In certain embodiments, the server can also receive and transmit messages (e.g., as a relay, content filter, etc.) between the first user and/or the other users instead of direct device-to-device communication.

In accordance with at least one aspect of this disclosure, the methods and/or systems can be stored on any suitable non-transitory computer readable storage medium. For example a non-transitory computer readable storage medium can include one or more computer programs embedded therein, the one or more computer programs comprising instructions, which when executed by a computer system, cause the computer system to receive group data from a first user, said group data including one or more topics, to create a public messaging group, and display a list of other users that have joined the public messaging group to the first user. Any other suitable portions of a method are contemplated herein.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this disclosure, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

1. A lost-and-found label for a lost and found system, comprising:
an adherent surface for attaching the label to an item;
a viewing surface on an opposite side of the label from the adherent surface;
a bar code registerable with the lost and found system printed on the viewing surface of the label; and
a text message number printed adjacent the bar code on the viewing surface of the label, the phone number linked to a server configured to receive and interpret an image of the bar code to determine if the bar code is registered to an item registered within the lost and found system such that the bar code and the text message number combination allow a finder to send an image of the bar code to the server via text message to report a found item and to receive a response from the lost and found system.

2. The label of claim 1, wherein the bar code is a QR code.

3. The label of claim 2, wherein the text message number is a phone number.

4. The label of claim 3, further comprising print that indicates a reward will be given for return of the lost item, the print being printed on the viewing surface.

5. The label of claim 4, wherein the print includes the term “REWARD.”

6. A computer-implemented method, comprising:
receiving a text message from a mobile device of a finder comprising an image of a lost-and-found label;
reading a bar code in the image of the label;
comparing the bar code to a database of registered items to determine if the bar code is registered to an item;
if the bar code is registered to an item, determining the item to be a found item; and
sending one or more response text messages to the mobile device that sent the image to execute a return and reward procedure.

7. The computer-implemented method of claim 8, wherein the one or more response text messages includes an image of a return shipping label.

8. The computer-implemented method of claim 8, wherein the one or more response text messages includes a link to an app or website associated with the lost and found system for additional information to be input.

9. The computer-implemented method of claim 8, further comprising receiving a finder's shipping address from the finder and causing shipment of a return box of a predetermined size configured to fit the found item therein and a shipping label to the finder's shipping address.

10. A server, comprising:
a memory;
a processor disposed in communication with said memory, and configured to issue a plurality of instructions stored in the memory, wherein the instructions cause the processor to perform a method comprising:
receiving a text message from a mobile device of a finder comprising an image of a lost-and-found label;
reading a bar code in the image of the label;
comparing the bar code to a database of registered items to determine if the bar code is registered to an item;
if the bar code is registered to an item, determining the item to be a found item; and
sending one or more response text messages to the mobile device that sent the image to execute a return and reward procedure.
